(19) United States
(12) Patent Application Publication
(10) Pub. No.: US 2009/0235267 A1
(43) Pub. Date: Sep. 17, 2009

(54) CONSOLIDATED DISPLAY OF RESOURCE PERFORMANCE TRENDS

(75) Inventors: Howard M. McKinney, Austin, TX (US); John C. Sanchez, Pflugerville, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/047,747

(22) Filed: Mar. 13, 2008

(51) Int. Cl. G06F 9/50

(52) U.S. Cl. 718/104

(57) ABSTRACT

A consolidated representation of performance trends for a plurality of resources in a data processing system is generated. Recent performance measurement data for the plurality of resources is retrieved along with historical performance measurement data for the plurality of resources. For each resource, an associated performance trend is determined based on an analysis of the recent performance measurement data and the historical performance measurement data. A single consolidated graphical representation of the plurality of resources is generated based on the associated performance trends. Each resource in the plurality of resources may have a separate representation within the single consolidated graphical representation positioned within the single consolidated graphical representation based on a recent performance trend and an associated historical performance trend. The single consolidated graphical representation may be output for use by a user to identify areas of the data processing system requiring the user's attention.

### BACKGROUND OF THE INVENTION

1. Field of the Invention

The present application relates generally to an improved data processing apparatus and method and more specifically to an apparatus and method for providing a consolidated display of resource performance trends.

2. Background of the Invention

With the proliferation and increased connectivity of different enterprises on the Internet, mechanisms have been developed for monitoring the performance of the computing system infrastructures and resources that support these enterprises. Such mechanisms typically gather metric data for monitoring the performance of the computing system infrastructure and resources using software agents. Mechanisms for graphing or charting the performance of the resources and infrastructure based on the gathered metric data may also be provided. Such graphing and charting mechanisms generate presentations of data across multiple views requiring a user to look at different charts for the relevant data and then aggregate this information, themselves in their own mind, on the fly in order to make evaluations.

### BRIEF SUMMARY OF THE INVENTION

In one illustrative embodiment, a method, in a data processing system, is provided for generating a consolidated representation of performance trends for a plurality of resources in the data processing system. The method may comprise retrieving recent performance measurement data for the plurality of resources and retrieving historical performance measurement data for the plurality of resources. The method may further comprise determining, for each resource in the plurality of resources, an associated performance trend based on an analysis of the recent performance measurement data and the historical performance measurement data. Moreover, the method may comprise generating a single consolidated graphical representation of the plurality of resources based on the associated performance trends. Each resource in the plurality of resources may have a separate representation within the single consolidated graphical representation positioned within the single consolidated graphical representation based on a recent performance trend and an associated historical performance trend. The method may further comprise outputting the single consolidated graphical representation.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary diagram of a distributed data processing system in accordance with one illustrative embodiment;

FIG. 2 is an exemplary diagram of a data processing device in which exemplary aspects of the illustrative embodiments may be implemented;

FIG. 3 is an exemplary block diagram illustrating a distributed electronic enterprise system whose performance may be monitored and represented using the mechanisms of the illustrative embodiments;

FIG. 4A is an exemplary diagram of an application availability representation for a limited specified recent time period;

FIG. 4B is an exemplary diagram of a performance measurement data representation for a historical time period for a single resource;

FIG. 5A is an exemplary diagram of a performance chart output generated by a performance monitoring and representation engine in accordance with one illustrative embodiment;

FIG. 5B is a chart indicating the performance classification of resources falling into various portions, e.g., quadrants, of the performance chart of FIG. 5A in accordance with one illustrative embodiment;

FIG. 6 is an exemplary block diagram of a performance monitoring and representation engine in accordance with one illustrative embodiment; and

FIG. 7 is a flowchart outlining an exemplary operation for generating a performance chart output in accordance with one illustrative embodiment.

### DETAILED DESCRIPTION OF THE INVENTION

The illustrative embodiments provide a mechanism for providing a consolidated display of resource performance. The illustrative embodiments may gather performance metric data from one or more resources of a data processing system, such as an electronic enterprise, and use this performance metric data to generate a consolidated display of resource performance for the one or more resources showing both recent and historical performance for the one or more resources. These resources may be provided in an individual computing device or may be provided by a plurality of computing devices in a distributed data processing system.

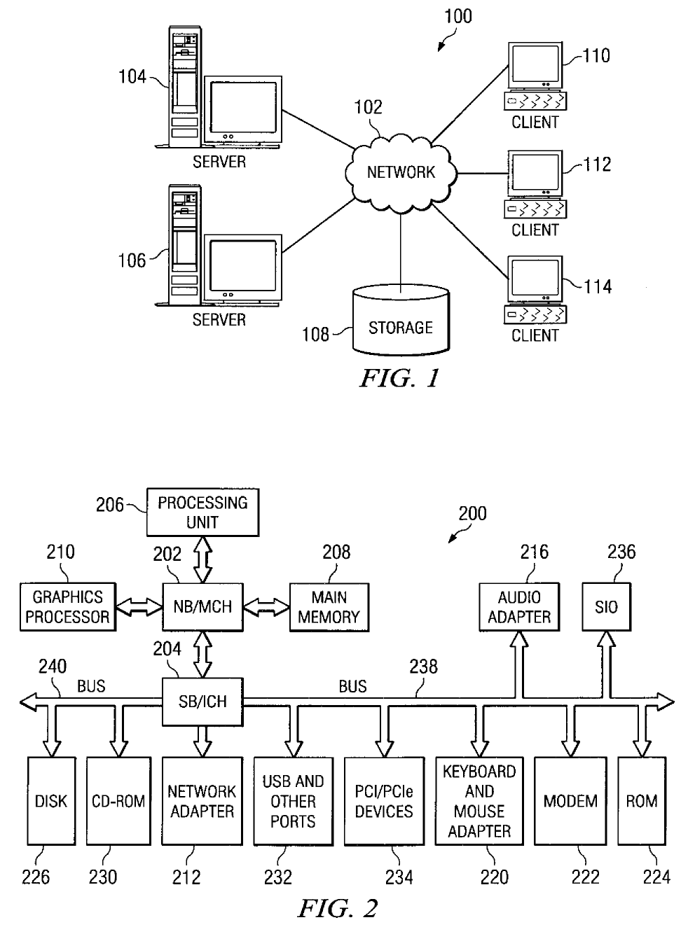

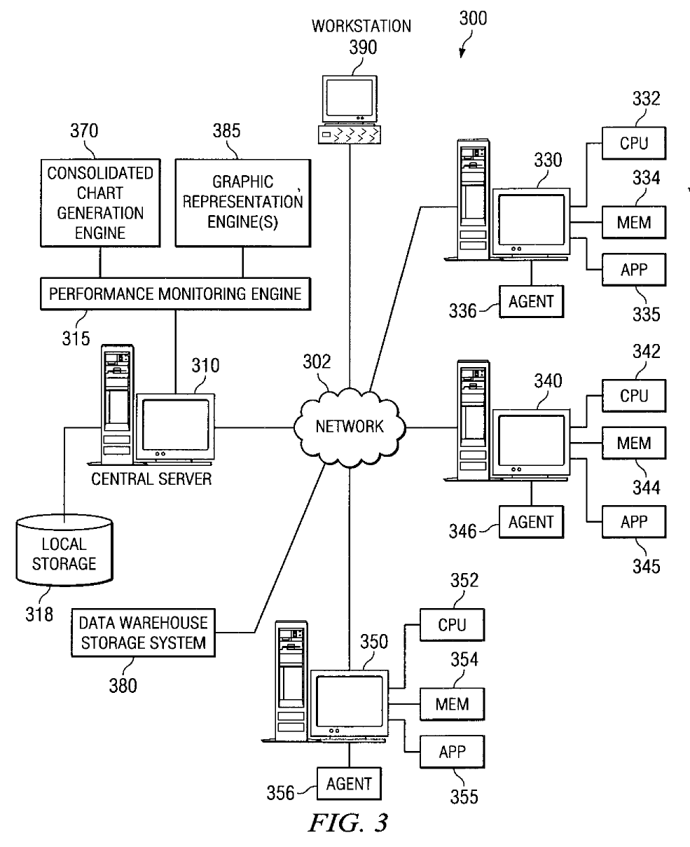

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as exemplary environments in which exemplary aspects of the illustrative embodiments may be implemented. While the description following FIGS. 1 and 2 will focus primarily on a distributed data processing device implementation, this is only exemplary and is not intended to state or imply any limitation with regard to the features of the present invention. To the contrary, the illustrative embodiments are intended to include single data processing device environments and other environments in which performance metric data may be gathered and used to generate a consolidated display of resource performance.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskettes, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It shouldalso be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

As mentioned above, the illustrative embodiments provide a mechanism for providing a consolidated display of resource performance. The illustrative embodiments may gather performance metric data from one or more resources of data processing system and use this performance metric data to generate a consolidated display of resource performance for the one or more resources showing both recent and historical performance for the one or more resources. These resources may be provided in an individual computing device or may be provided by a plurality of computing devices in a distributed data processing system. In one illustrative embodiment, these resources are provided in a plurality of computing devices of an electronic enterprise infrastructure comprising one or more distributed data processing systems. Each of the computing devices may have one or more associated agents executing thereon whose duty it is to collect performance metric information and provide that performance metric information to a central server computing device that executes a performance monitoring engine.

The one or more associated agents may monitor the performance of resources, e.g., memory, CPU, storage space, bandwidth, applications, etc., with regard to actual transactions originating from actual users or with regard to robotic, i.e. simulated, transactions during times of relative idleness of the data processing system. Such monitoring of performance may be performed in real-time to generate metrics indicative of the performance of these resources. In one illustrative embodiment, the performance of the resources is monitored to collect metric data regarding the end-user response time experience associated with a resource, e.g., an application. Typically, the agents produce real-time metric data records that are provided to the central server which then aggregates these records to generate a performance metric, such as average response time, average number of requests handled, etc.

In one illustrative embodiment, the performance monitoring engine may be a modified version of the International Business Machines (IBM) Tivoli Composite Application Manager for Response Time (ITCAMfRT) available from IBM Corporation of Armonk, N.Y. In such an embodiment, the ITCAMfRT is modified by the present invention so as to generate a single unified or consolidated chart representation of the performance of a plurality of resources with both their recent and historical performance being charted. Rather than the many different representations used in known systems to represent each resource individually or different metrics in different views, thereby requiring a user to navigate back and forth between views to gather the information they need, the illustrative embodiments permit a plurality, or even all, of the resources of an electronic system, and their associated performance metric information, to be represented in a single relational chart of recent and historical performance. In this way, the performance of resources may be compared to identify those requiring immediate attention and those that are not necessarily in need of immediate attention by a system administrator.

In one illustrative embodiment, the single consolidated representation of resource performance comprises a bubble chart. Each resource is represented in the bubble chart as a bubble having a size that represents the relative magnitude, or the relative importance, of the monitored resource. The position of the bubble in the bubble chart is dependent upon a performance trend of the associated resource both recently and historically. In one illustrative embodiment, portions of the bubble chart are associated with resources whose performance is categorized as slipping (e.g., historically performance is steady or increasing, but recently performance is decreasing), lagging (e.g., historically performance is decreasing and recently performance continues to decrease), leading (e.g., historically performance is steady or increasing and recently performance is increasing), and improving (historically performance is decreasing, but recently performance is increasing). The bubble representations in the bubble chart may be selectable such that additional detailed information regarding the associated resource and its associated performance measurements may be obtained in response to the selection of the bubble representation.

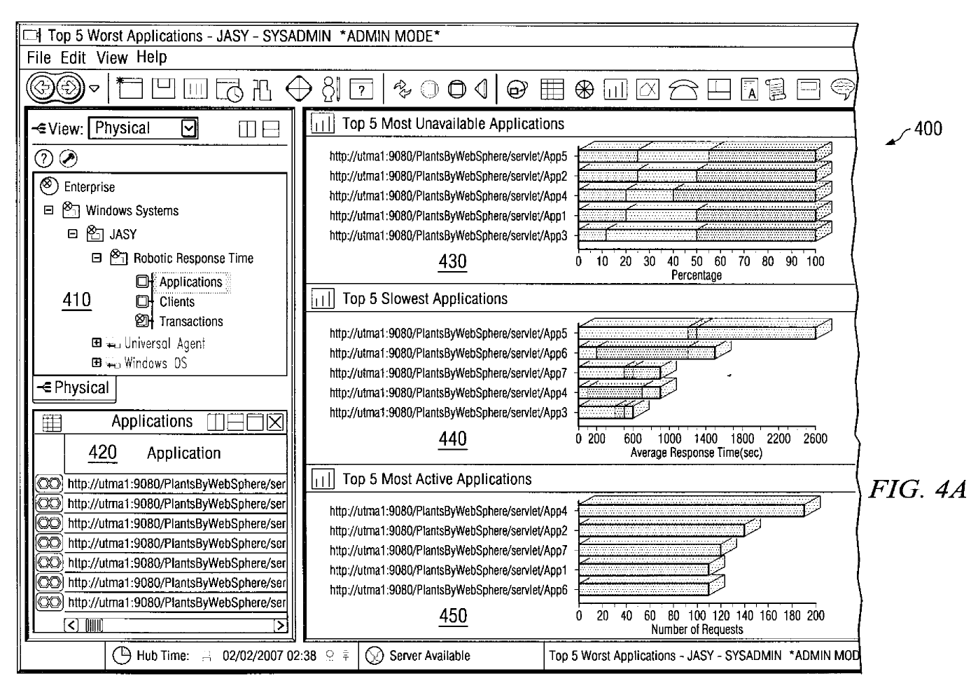

FIG. 3 is an exemplary block diagram illustrating a distributed electronic enterprise system whose performance may be monitored and represented using the mechanisms of the illustrative embodiments. As shown in FIG. 3, the electronic enterprise is comprised of a central server 310 having an associated performance monitoring engine 315 executing thereon. A system administrator workstation 320 may be coupled to the server 310 for accessing and viewing representations of performance measurements generated based on metric data gathered for a plurality of electronic enterprise system resources. These system resources may be present on one or more computing devices 330, 340, and 350 of the electronic enterprise system 300.

The computing devices 330, 340, and 350 have a plurality of resources 332-335, 342-345, and 352-355 as well as agent applications 336, 346, and 356. The agent applications 336, 346, and 356 monitor various performance metrics of the resources 332-335, 342-345, and 352-355 and generate data records that are returned to the central server 310. The central server 310 may aggregate these data records to generate performance measurements or information representative of the availability, response time, and other measures of performance of the resources 332-335, 342-345, and 352-355.

The central server 310 generates both recent performance measurement data or information as well as historical performance measurement data or information. Recent performance measurement data may be performance measurement data that has been generated based on gathered metric data within a predetermined shortened time period from a current time, e.g., within the past 10 minutes, 30 minutes, hour, etc. Historical performance measurement data is performance measurement data that was generated based on gathered metric data that is older than the predetermined shortened time period from a current time, e.g., over 1 hour old. Recent performance measurement data is maintained within a data structure maintained in a local storage device 318 associated with the performance monitoring application 315. Historical performance measurement data or information is warehoused data that is transmitted from the performance monitoring application 315 to a data warehouse storage system 380 on a periodic basis, e.g., every hour, 12 hours, 24 hours, etc., such as via the network 302. The particular definition of the separation of historical performance measurement data from recent, or live, performance data may be dependent upon the particular implementation. In general, however, the difference may be determined as historical performance measurement data is typically archived at in a storage device that is typically remotely located, but may be local in some implementations, while recent or live performance measurement data is not yet archived.

The central server 310 further comprises a consolidated chart generation engine 370 executing on the central server 310 which, in accordance with the illustrative embodiments, generates a consolidated chart representation of the performance measurements or information for the plurality of resources 332-335, 342-345, and 352-355. The consolidated chart generation engine 370 may further interface with other graphic representation engines 385 running on the central server 310, such as may be part of the performance monitoring engine 315, for example, so that a combination of representations may be generated and linked in such a manner that one representation may be obtained using graphical user interface elements of another representation. For example, elements of the consolidated chart generated by the consolidated chart generation engine 370 may be user selectable with the result of such selection being the accessing of representations of resource performance information that are generally known in the art. Thus, the consolidated chart may be an interface through which more detailed information of resources may be accessed, such as in a format that is more familiar with users of legacy systems. The consolidated chart may be provided to a user workstation 390 in response to a request from the user workstation 390 for data processing system performance information, for example.

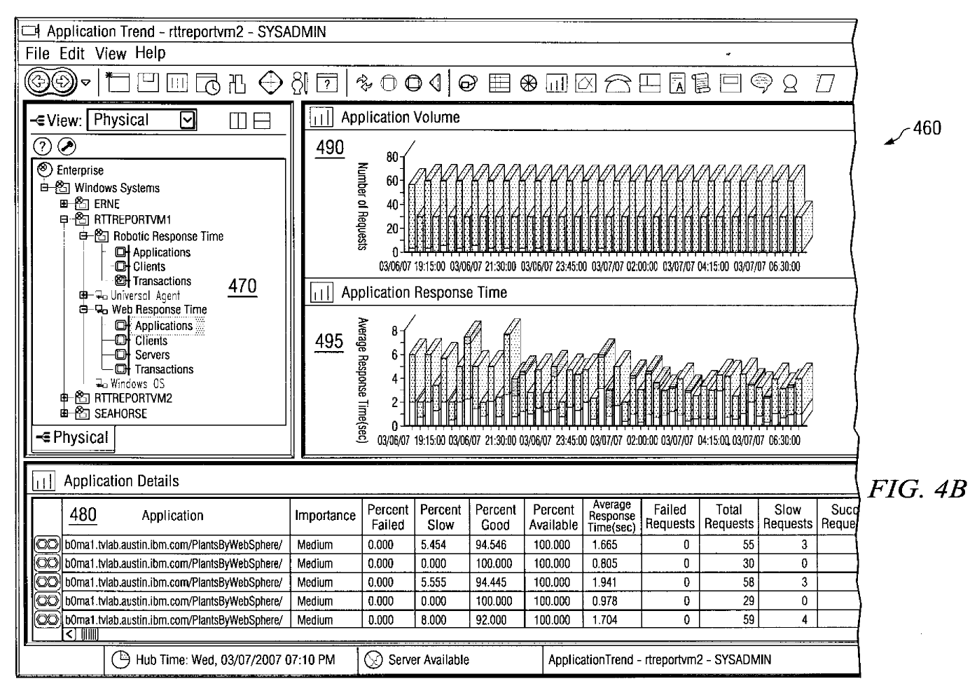

FIG. 4A is an exemplary diagram of an application availability representation for a limited specified recent time period. As shown in FIG. 4A, graphical user interface 400 includes a first portion 410 for selecting a resource category for which a representation of performance information is desired, e.g., “applications.” A second portion 420 is provided for displaying the actual resource identifiers, e.g., fill path identifiers, of the resources in the selected resource category of the first portion 410. A third portion 430 is provided for identifying the top 5 most unavailable applications within the specified recent time period, e.g., past 5 minutes. A fourth portion 440 is provided for identifying the top 5 slowest applications within the specified recent time period. A fifth portion 450 is provided for identifying the top 5 most active applications in the specified recent time period.

The graphical user interface 400 may be generated by a representation engine of the performance monitoring engine 315 on a system administrator workstation 320, for example. The performance measurement data that is used to generate the representations in the various portions 430-450 of the graphical user interface 400 is recent performance measurement data stored in a local storage 318 of the performance monitoring engine 315 of the central server 310, for example. It can be seen from FIG. 4A that none of the representations in portions 430-450 provide any historical trend information regarding the various resources, e.g., applications, but instead are only directed to ranking the resources according to recent performance measurement data and providing a representation of performance information of the worst ranked resources. The representations shown in portions 430-450 are not generated based on warehoused, or archived, data accessed from a data warehouse storage system 380. Thus, while the representations shown in portions 430-450 provide a representation of recent performance data for more than one resource, there is no ability to obtain an indication of the historical performance trend of these resources, over an extended period of time.

FIG. 4B is an exemplary diagram of a performance measurement data representation for a historical time period for a single resource. As shown in FIG. 4B, the graphical user interface 460 includes a first portion 470 for selecting a resource category, e.g., applications, under a measurement category, e.g., Web Response Time, Robotic Response Time, etc. A robotic response time refers to performance measurement data obtained using robotic transactions rather than actual transactions from actual client computing devices. Web response time refers to performance measurement data obtained from actual client transactions.

A second portion 480 is provided for setting forth the details of each of the resources in the selected resource category, e.g., applications. As shown in FIG. 4B, this second portion 480 provides details regarding the resource identifier, e.g., path and filename, an importance level associated with the resource, and various performance measurement data obtained from aggregating the metric data records returned from agents running on the computing devices providing the resources. The data used to generate the performance measurement data represented in this second portion is historical performance measurement data that may be warehoused in a data warehouse storage system 380, for example.

A third portion 490 is provided for graphing or charting a first performance measurement for a selected resource, e.g., a selected application from the list shown in the second portion 480. In the depicted example, the third portion 490 depicts the number of requests received by the selected application over a historical time period bridging Mar. 6, 2007 to Mar. 7, 2007. Similarly, a fourth portion 495 is provided for graphing or charting a second performance measurement for the selected resource, e.g., average response time, for the same historical time period.

As can be seen from FIG. 4B, in order for a user to see the historical performance measurement data for each of the resources in the selected resource category, the user is required to select each resource individually, one-by-one, from the listing provided in the second portion 480. A user cannot compare different resource performance trends in a single view. To the contrary, a user would be required to open additional graphical user interface instances for each individual resource and then switch between them to attempt to obtain an overall understanding of the historical performance trend of the resources as a whole. This does not scale well for the user and makes comparisons of historical performance trends of the various resources very difficult to achieve.

As discussed above, the illustrative embodiments provide mechanisms for generating a consolidated view of the recent and historical performance measurement data for a plurality of resources. This consolidated chart representation of the recent and historical performance data is able to more effectively convey availability, response time, and other performance measurement data so that a user may focus on trouble areas in a complex data processing system, such as an electronic enterprise or the like.

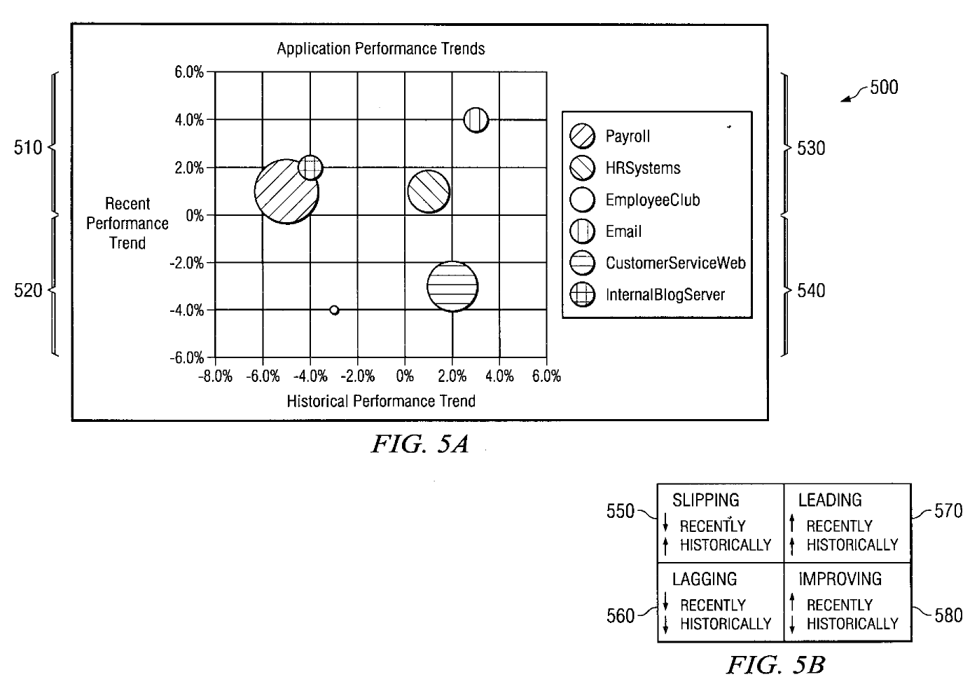

FIG. 5A is an exemplary diagram of a performance chart output generated by a performance monitoring and representation engine in accordance with one illustrative embodiment. As shown in FIG. 5A, the performance chart 500 is a bubble chart having portions, e.g., quadrants, representative of different performance trends of the resources represented. Each resource that is to be represented in the performance chart 500 is represented as a bubble in the chart 500. Bubbles have a size that represents the relative magnitude, or importance, of the monitored resource. This relative size may be generated based on a user defined importance level associated with the resource, such as the importance level illustrated in the second portion 480 of FIG. 4B. Alternatively, this importance level may be automatically determined by the performance monitoring engine in response to the determination of recent and/or historical performance information, such as number of transactions over time, percent of transactions over time, or the like. For example, an application receiving a number of transactions over a specified time period that exceeds a first threshold may be classified as high important, a second threshold but not the first threshold may be classified as a moderately important application, and not exceeding either the first or second threshold may be classified as a low importance application. Such thresholds may be user defined or otherwise automatically determined based on a statistical analysis, or other type of automated analysis, of the performance measurement data generated based on the collected metric data records from the agents.

Bubbles may overlap each other with smaller sized bubbles being represented on top of larger sized bubbles for viewability reasons. Alternatively, since smaller sized bubbles represent relatively lower importance resources, larger sized bubbles may be allowed to obscure the viewability of the smaller sized bubbles in some implementations. Various colors, patterns, highlighting, flashing, pulsing, or any other known graphical technique may be used to accentuate the differences between bubbles so that it is easy for a user to distinguish bubbles from one another and distinguish relative importance of bubbles from one another.

The placement of the bubbles on the chart is dependent upon an analysis of the recent and historical trends in performance of the associated resources. In one illustrative embodiment, if performance of a resource is recently decreasing, as determined from an analysis of the most recent performance measurement data for the resource, but has been improving historically, as determined from an analysis of the historical performance data warehoused in the data warehouse storage system, then the bubble for representing the resource may be placed in a first portion, e.g., a quadrant, of the chart 500. If performance of a resource is recently decreasing, as determined from an analysis of the most recent performance measurement data for the resource, and has been decreasing historically, as determined from an analysis of the historical performance data warehoused in the data warehouse storage system, then the bubble for representing the resource may be placed in a second portion of the chart 500. Similarly, if performance of a resource is recently increasing, as determined from an analysis of the most recent performance measurement data for the resource, and has been improving historically, as determined from an analysis of the historical performance data warehoused in the data warehouse storage system, then the bubble for representing the resource may be placed in a third portion of the chart 500. If performance of a resource is recently increasing, as determined from an analysis of the most recent performance measurement data for the resource, but has been decreasing historically, as determined from an analysis of the historical performance data warehoused in the data warehouse storage system, then the bubble for representing the resource may be placed in a fourth portion of the chart 500.

The particular point at which the bubble for a resource is placed in the various portions of the chart 500 is dependent upon the amount by which performance is increasing and/or decreasing both recently and historically. The performance measure that is used in the generation of the chart 500 may be any performance measure generated based on the recent and historical performance measurements generated based on metric data records gathered from the various agents in the distributed data processing system. Alternatively, an overall performance measurement, for recent performance and separately for historical performance, based on a variety of performance measurements may be generated based on one or more established functions that combine these various performance measurements to generate an overall measurement of the performance of the resource.

In one illustrative embodiment, the analysis of the recent and historical performance measurement data generates a percentage change in the performance measurement over the recent and historical time periods. The change in recent performance measurement may be used to map the center of the bubble along one axis of the chart 500 while the change in historical performance measurement may be used to map the center of the bubble along a second axis of the chart 500. From the placement of the center of the bubble on the chart 500, the bubble may be drawn having a size corresponding to the determined importance level of the associated resource.

The bubble that is generated in this manner may be selectable via a user interface, such as via a computer mouse, keyboard, or other known user interface. If the bubble is selected in this manner, detailed performance measurement information may be provided to the user in a “drill-down” manner, For example, a representation similar to that shown in FIG. 4A and/or FIG. 4B may be provided in response to a user selecting a bubble. In this way, the chart 500 may be used to provide a distributed data processing system view having bubbles for each of the monitored resources of the distributed data processing system, or at least a significant subset of the monitored resources, e.g., resources having an importance level above a predetermined threshold or that have a problem condition associated with them, e.g., a performance measurement below a determined threshold, while the other “drilled-down” representation may be specific to a particular resource or at least a subset of the monitored resources represented in the chart 500.

FIG. 5B is a chart indicating the performance classification of resources falling into various portions, e.g., quadrants, of the performance chart of FIG. 5A in accordance with one illustrative embodiment. As shown in FIG. 5B, a first portion 510 (e.g., upper left quadrant) of the chart 500 is associated with applications whose performance trend is evaluated to be in a “slipping” category 550. This “slipping” category 550 represents those applications whose performance measurements, e.g., availability and response time measurements, indicate that the application has historically been increasing in performance but recently has been decreasing in performance.

A second portion 520 (e.g., bottom left quadrant) of the chart 500 is associated with applications whose performance trend is evaluated to be a “lagging” category 560. This “lagging” category 560 represents those applications whose performance measurements, e.g., availability and response time measurements, indicate that the application has historically been decreasing in performance and has recently continued to decrease in performance. A third portion 530 (e.g., upper right quadrant) of the chart 500 is associated with applications whose performance trend is evaluated to be a “leading” category 570. This “leading” category 570 represents those applications whose performance measurements, e.g., availability and response time measurements, indicate that the application has historically been increasing in performance and has recently continued to increase in performance. A fourth portion 540 (e.g., lower right quadrant) of the chart 500 is associated with applications whose performance trend is evaluated to be an “improving” category 580. This “improving” category 580 represents those applications whose performance measurements, e.g., availability and response time measurements, indicate that the application has historically been decreasing in performance and has recently started to increase in performance.

With specific reference to the example shown in FIGS. 5A and 5B, the example illustrates how resources, which in this example are applications, in a monitored distributed data processing system, which in this case is an electronic enterprise, may have their recent and historical performance, in terms of availability and response time, depicted in a single consolidated chart 500. In this example, the “Email” and “HRSystems” applications are leading in their current performance measurements, i.e. recent performance measurement data, compared to their individual baselines. Thus, their respective bubbles 590 and 592 are depicted in FIG. 5A in the third portion 570 of the chart 500. The HRSystems application has a relatively higher importance than that of the Email application and thus, has a larger size bubble 590 than the bubble 592 associated with the Email application.

The “EmployeeClub” application is lagging in this example and thus, is depicted in the second portion 560 of the chart 500. However, the EmployeeClub application has a much lower importance than any of the other monitored applications represented in the chart 500. The size of the bubble 593 associated with the EmployeeClub application indicates to the user that this application, while lagging in its performance, is not critical to the electronic enterprise and thus, it is not urgent that the performance problems associated with this application be immediately addressed.

Two applications, i.e. the “Payroll” application and the “InternalBlogServer” application, are indicated as “slipping” in performance in this example and thus, have their bubble representations presented in the first portion 550 of the chart 500. This means that each application has been performing well historically, but has suffered some response time degradations recently. The sizes of the bubbles 594 and 595 indicate that the Payroll application (bubble 594) is much more important than the InternalBlogServer application (bubble 595). Thus, the Payroll application will receive attention before the InternalBlogServer application.

The “CustomerServiceWeb” application is depicted as “improving” and has its associated bubble 596 positioned in the fourth portion 580. The bubble 596 size indicates that it is a relatively important application. However, since it is improving in performance, it may be less important to direct attention to this application than important applications present in the slipping and lagging portions 510 and 520 of the chart 500.

Thus, from this one consolidated chart 500 representation of the performance trends of the resources of the distributed data processing system, it can be determined which resources have been performing well and are continuing to perform well, which resources are performing well but historically have not been performing well, which resources have historically been performing well but have recently started to slip in performance, and which resources have historically and recently not been performing well. Moreover, from this one consolidated chart 500 representation, it can be determined the relative importance of such resources appearing in these different performance trend categories. Thus, the focus points of the efforts of a system administrator may be quickly determined so that the system administrator's time is efficiently utilized in addressing the most urgent of issues existing in the distributed data processing system.

It should be appreciated that while the example implementation shown in FIGS. 5A and 5B illustrates a two-dimensional chart having particular attributes described above, this is only exemplary of the possible implementations of the present invention. Other illustrative embodiments may make use of multi-dimensional charts or graphs having dimensions greater than two, such as a three-dimensional or four dimensional chart, depending upon the various performance trends, performance measurements, and the like, that are included in the implementation. Moreover, while a bubble chart is shown in the above examples, other charts in which a single chart representation may be provided that identifies at least recent and historical performance trends of a plurality of resources in a single consolidated chart may be used without departing from the spirit and scope of the present invention.

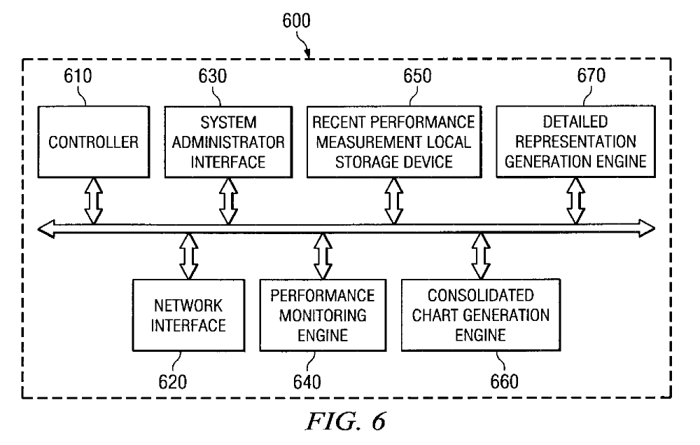

FIG. 6 is an exemplary block diagram of a performance monitoring and representation engine in accordance with one illustrative embodiment. The elements shown in FIG. 6 may be implemented in software, hardware, or any combination of software and hardware. In one illustrative embodiment, the elements of FIG. 6 are implemented as software instructions executed by one or more instruction processing devices.

As shown in FIG. 6, the performance monitoring and representation engine 600 includes a controller 610, a network interface 620, a system administrator interface 630, a performance monitoring engine 640, a recent performance measurement local storage device 650, a consolidated chart generation engine 660, and a detailed representation generation engine 670. The controller 610 controls the overall operation of the performance monitoring and representation engine 600 and orchestrates the operation of the other elements 620-670. The controller 610 may send control data to remotely located agent applications on remote computing devices and receive metric data records generated and transmitted by these agents to the performance monitoring and representation engine 600 via the network interface 620.

The controller 610 may provide these metric data records to the performance monitoring engine 640. The performance monitoring engine 640 may perform various analysis of the received metric data records to aggregate these metric data records into performance measurement data or information for the resources monitored by the agent applications. The performance measurement data or information may be stored in the recent performance measurement local storage device 650. Periodically, data in the recent performance measurement local storage device 650 may be migrated by the performance monitoring engine 640 to a remotely located data warehouse storage system via the network interface 620 for warehousing until needed. The periodicity of such migrations may be user defined, such as in a configuration file or the like, associated with the performance monitoring and representation engine 600.

The consolidated chart generation engine 660, in response to a request received from a system administrator workstation or the like, via the system administrator interface 630, may access recent performance measurement data or information in the recent performance measurement local storage device 650 and historical performance measurement data or information in the remotely located data warehouse, via the network interface 620. The recent and historical performance measurement data may be analyzed by the consolidated chart generation engine 660 to generate a consolidated chart identifying the recent and historical performance trends of a plurality of resources in a single chart. Moreover, the consolidated chart generation engine 660 may obtain relative importance data, such as from a configuration file or the like, or automatically determine the relative importance of resources based on an analysis of a portion of the recent and/or historical performance measurement data. This relative importance information may be used by the consolidated chart generation engine 660 to generate representations of the resources that indicate their relative importance.

The detailed representation generation engine 670 may generate other detailed graphical representations of individual application historical performance measurements, or only recent performance measurements for a subset of resources, or the like. These detailed representations may be linked to the representations of resources in the consolidated chart generated by the consolidated chart generation engine 660 such that the selection of an element in the consolidated chart may result in the presentation of a detailed representation generated by the detailed representation generation engine 670. The consolidated chart and detailed representations may be presented to a user via their workstation and the system administrator interface 630 in response to a request from the user.

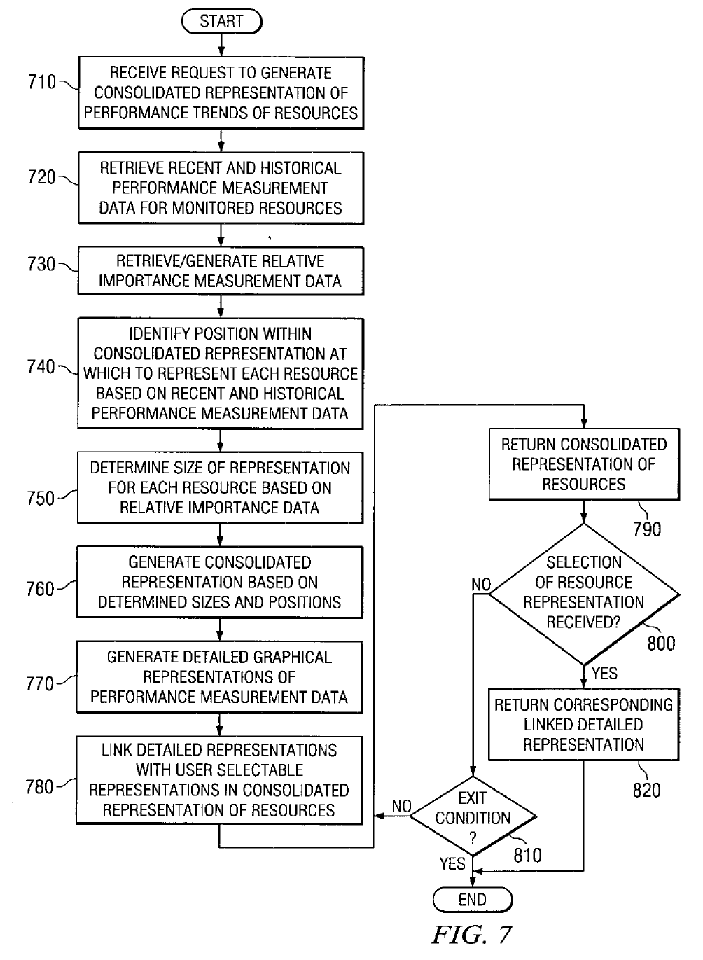

FIG. 7 is a flowchart outlining an exemplary operation for generating a performance chart output in accordance with one illustrative embodiment. The operation outlined in FIG. 7 may be performed, for example, by a performance monitoring and representation engine, such as shown in FIG. 6, for example. The various operations set forth in FIG. 7 may be performed, for example, by various ones of the elements of the performance monitoring and representation engine as previously described above.

As shown in FIG. 7, the operation starts with the receipt of a request to generate a consolidate representation of performance trends of resources in a data processing system (step 710). The performance monitoring and representation engine retrieves recent and historical performance measurement data for the monitored resources of the data processing system (step 720). In one illustrative embodiment, the request may specify a subset of resources of interest and thus, recent and historical performance measurement data may be retrieved only for those resources specified in the request.

The performance monitoring and representation engine may further retrieve, or generate, relative importance measurement data for the various resources (step 730). The recent and historical performance measurement data are used to identify a position within a consolidated representation at which a representation for each resource is to be centered (step 740). A size of the representation for each resource is determined based on the relative importance measurement data (step 750). The consolidated representation of resources of the data processing system is generated with representations for each resource being positioned at the positions determined in step 740 and having sizes determined in step 750 (step 760). Detailed graphical representations of performance measurement data for each of the resources is generated (step 770) and these detailed graphical representations are linked with user selectable representations of the corresponding resources in the consolidated representation of resources (step 780). The consolidated representation of resources is returned to the source of the request (step 790).

A determination is made as to whether a selection of a resource representation in the consolidated representation is received (step 800). If not, the operation determines if an exit condition has occurred, e.g., system administrator logs off of the system or the like (step 810). If not, the operation returns to step 800. If an exit condition has occurred, the operation terminates.

If a selection of a resource representation in the consolidated representation is received, then a corresponding linked detailed graphical representation is returned to the source of the request (step 820). The operation then returns to step 800.

Thus, the illustrative embodiments provide mechanisms for generating and presenting a consolidated representation of the recent and historical performance trends of a plurality of resources in a single representation. The mechanisms of the illustrative embodiments alleviate the frustration of using multiple views to present historical performance measurement data for resources or using a limited view of only recent performance measurement data for a limited number of resources. With the consolidated representation of the illustrative embodiments, a user may quickly obtain an understanding of the recent and historical performance trends of resources and their relative importance such that efforts may be quickly directed to areas where these efforts are most needed to efficiently improve the overall performance of the data processing system.

As noted above, it should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for generating a consolidated representation of performance trends for a plurality of resources in the data processing system, comprising:
retrieving recent performance measurement data for the plurality of resources;
retrieving historical performance measurement data for the plurality of resources;
determining, for each resource in the plurality of resources, an associated performance trend based on an analysis of the recent performance measurement data and the historical performance measurement data;
generating a single consolidated graphical representation of the plurality of resources based on the associated performance trends, wherein each resource in the plurality of resources has a separate representation within the single consolidated graphical representation positioned within the single consolidated graphical representation based on a recent performance trend and an associated historical performance trend; and
outputting the single consolidated graphical representation.

2. The method of claim 1, wherein the recent performance measurement data is performance measurement data that has not been archived.

3. The method of claim 1, wherein the historical performance measurement data is retrieved from an archive of data on a data warehouse storage system.

4. The method of claim 1, further comprising:
gathering performance metrics for the plurality of resources using one or more agents on one or more computing devices in the data processing system; and
calculating the recent performance measurement data for the plurality of resources based on the gathered performance metrics.

5. The method of claim 1, wherein the recent performance measurement data is periodically archived to generate the historical performance measurement data.

6. The method of claim 1, wherein the single consolidated graphical representation of the plurality of resources is a bubble chart in which the separate representations of the resources are bubbles within the bubble chart.

7. The method of claim 6, wherein each bubble associated with each resource in the bubble chart has a size, and wherein the size of a bubble is determined based on a relative importance of the resource associated with the bubble.

8. The method of claim 6, wherein the bubble chart has portions representative of different performance trends and wherein a position of a bubble associated with a resource is in one of the portions based on a determined performance trend of that resource.

9. The method of claim 8, wherein the portions comprise:
a first portion associated with a slipping performance trend in which a resource's historical performance measurement data indicates a performance that is steady or increasing and the resource's recent performance measurement data indicates a performance that is decreasing,
a second portion associated with a lagging performance trend in which the resource's historically performance measurement data indicates a performance that is decreasing and the resource's recent performance measurement data indicates a performance that is decreasing,
a third portion associated with a leading performance trend in which the resource's historical performance measurement data indicates a performance that is steady or increasing and the resource's recent performance measurement data indicates a performance that is increasing, and
a fourth portion associated with an improving performance trend in which the resource's historical performance measurement data indicates a performance that is decreasing and the resource's recent performance measurement data indicates a performance that is increasing.

10. A computer program product comprising a computer recordable medium having a computer readable program recorded thereon, wherein the computer readable program, when executed on a computing device, causes the computing device to:
retrieve recent performance measurement data for a plurality of resources;
retrieve historical performance measurement data for the plurality of resources;
determine, for each resource in the plurality of resources, an associated performance trend based on an analysis of the recent performance measurement data and the historical performance measurement data;
generate a single consolidated graphical representation of the plurality of resources based on the associated performance trends, wherein each resource in the plurality of resources has a separate representation within the single consolidated graphical representation positioned within the single consolidated graphical representation based on a recent performance trend and an associated historical performance trend; and
output the single consolidated graphical representation.

11. The computer program product of claim 10, wherein the recent performance measurement data is performance measurement data that has not been archived.

12. The computer program product of claim 10, wherein the historical performance measurement data is retrieved from an archive of data on a data warehouse storage system.

13. The computer program product of claim 10, wherein the computer readable program further causes the computing device to:
gather performance metrics for the plurality of resources using one or more agents on one or more computing devices in the data processing system; and
calculate the recent performance measurement data for the plurality of resources based on the gathered performance metrics.

14. The computer program product of claim 10, wherein the recent performance measurement data is periodically archived to generate the historical performance measurement data.

15. The computer program product of claim 10, wherein the single consolidated graphical representation of the plurality of resources is a bubble chart in which the separate representations of the resources are bubbles within the bubble chart.

16. The computer program product of claim 15, wherein each bubble associated with each resource in the bubble chart has a size, and wherein the size of a bubble is determined based on a relative importance of the resource associated with the bubble.

17. The computer program product of claim 15, wherein the bubble chart has portions representative of different performance trends and wherein a position of a bubble associated with a resource is in one of the portions based on a determined performance trend of that resource.

18. The computer program product of claim 17, wherein the portions comprise:
a first portion associated with a slipping performance trend in which a resource's historical performance measurement data indicates a performance that is steady or increasing and the resource's recent performance measurement data indicates a performance that is decreasing,
a second portion associated with a lagging performance trend in which the resource's historically performance measurement data indicates a performance that is decreasing and the resource's recent performance measurement data indicates a performance that is decreasing,
a third portion associated with a leading performance trend in which the resource's historical performance measurement data indicates a performance that is steady or increasing and the resource's recent performance measurement data indicates a performance that is increasing, and
a fourth portion associated with an improving performance trend in which the resource's historical performance measurement data indicates a performance that is decreasing and the resource's recent performance measurement data indicates a performance that is increasing.

19. An apparatus, comprising:
a processor; and
a memory coupled to the processor, wherein the memory comprises instructions which, when executed by the processor, cause the processor to:
retrieve recent performance measurement data for a plurality of resources;
retrieve historical performance measurement data for the plurality of resources;
determine, for each resource in the plurality of resources, an associated performance trend based on an analysis of the recent performance measurement data and the historical performance measurement data;
generate a single consolidated graphical representation of the plurality of resources based on the associated performance trends, wherein each resource in the plurality of resources has a separate representation within the single consolidated graphical representation positioned within the single consolidated graphical representation based on a recent performance trend and an associated historical performance trend; and
output the single consolidated graphical representation.

20. The apparatus of claim 19, wherein the single consolidated graphical representation of the plurality of resources is a bubble chart in which the separate representations of the resources are bubbles within the bubble chart.

21. The apparatus of claim 20, wherein each bubble associated with each resource in the bubble chart has a size, and wherein the size of a bubble is determined based on a relative importance of the resource associated with the bubble.

22. The apparatus of claim 20, wherein the bubble chart has portions representative of different performance trends and wherein a position of a bubble associated with a resource is in one of the portions based on a determined performance trend of that resource.

23. The apparatus of claim 22, wherein the portions comprise:
a first portion associated with a slipping performance trend in which a resource's historical performance measurement data indicates a performance that is steady or increasing and the resource's recent performance measurement data indicates a performance that is decreasing,
a second portion associated with a lagging performance trend in which the resource's historically performance measurement data indicates a performance that is decreasing and the resource's recent performance measurement data indicates a performance that is decreasing,
a third portion associated with a leading performance trend in which the resource's historical performance measurement data indicates a performance that is steady or increasing and the resource's recent performance measurement data indicates a performance that is increasing, and
a fourth portion associated with an improving performance trend in which the resource's historical performance measurement data indicates a performance that is decreasing and the resource's recent performance measurement data indicates a performance that is increasing.
